(19) United States
(12) Patent Application Publication
(10) Pub. No.: US 2010/0201702 A1
(43) Pub. Date: Aug. 12, 2010

(54) DIGITAL IMAGE PROJECTION LUMINAIRE SYSTEMS

(75) Inventors: Martin FRANIK, Postredni Becva (CZ); Josef Valcher, Postredni Becva (CZ); Pavel Jurik, Postredni Becva (CZ)

Correspondence Address: HEINZ GRETHER PC;G2 Technology Law, P.O. Box 202858, AUSTIN, TX, 78720, US

(73) Assignee: ROBE LIGHTING S.R.O.

(21) Appl. No.: 12/699,620

(22) Filed: Feb. 3, 2010

Related U.S. Application Data
(60) Provisional application No. 61/149,693, filed on Feb. 3, 2009.

(51) Int. Cl. G09G 5/02; G09G 5/00

(52) U.S. Cl. 345/589; 345/661

(57) ABSTRACT

The present invention provides improvements to digital imagine projection systems and for seamless blending of images projected from a plurality of digital image projectors to create combined images from multiple projectors where the user is provided with independent control of the blend area and of independent control of image parameters within said variable blend area such as brightness, contrast, individual color intensity and gamma correction.

### RELATED APPLICATION(S)

This application is a utility filing claiming priority of provisional application 61/149,693 filed 3 Feb. 2009.

### TECHNICAL FIELD OF THE INVENTION

The present invention generally relates to the projection of images and more specifically to imaging systems used for the projection of digital images.

### BACKGROUND OF THE INVENTION

Projection systems are commonly used in many different entertainment and commercial applications. Such products are commonly used in theatres, television studios, concerts, theme parks, night clubs and other venues. These systems may be used to project content from video sources such as DVD players or video cameras or may project a video stream that is computer generated. One application for such devices is as a luminaire where a video projection system is used as a light source giving the user full control over the imagery, color, patterns and light output of the luminaire. Examples of such a system are the Icon M from Light & Sound Design and the Digital Spot 7000DT from Robe Lighting SRO.

In many cases the imagery used in these projection luminaires is produced by a media server. A media server is usually a computer based system which allows the user to select a video image from an external library, manipulate and distort that image, combine it with other images and output the completed imagery as a video stream. Examples of some of the many different manipulations available might include image rotation & scaling, overlaying multiple images and color change. The outputs from a plurality of such automated luminaires may further be tiled or overlaid as the operator desires in order to produce either a much larger image comprising tiles from multiple luminaires tiled side by side or a single brighter image where identical images from multiple luminaires are fully overlaid. These media servers may be incorporated in the luminaire or they may be separate from the luminaire. In either case the media server may serve one or multiple luminaires providing such luminaires with signals which may contain image data generally in either digital or analog form. This disclosure provides improvements to image projecting luminaires.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an embodiment of picture blending in the invention with two projection luminaires;

FIG. 2 illustrates an embodiment of picture blending in the invention with four projection luminaires;

FIG. 3 illustrates an embodiment of gamma correction in the invention;

FIG. 4 illustrates an embodiment of kaleidoscopic tiling in the invention;

FIG. 5 illustrates an embodiment of image mirroring in the invention;

FIG. 6 illustrates an embodiment of image mirroring in the invention and of a non-flat projection surface;

FIG. 7 illustrates an embodiment of re-cutting an image in the invention;

FIG. 8 illustrates an embodiment of a test pattern of the invention;

FIG. 9 illustrates an embodiment of a linear gamma curve;

FIG. 10 illustrates an embodiment of a multi-luminaire system of the invention;

FIG. 11 illustrates an embodiment of color correlation in the invention; and

FIG. 12 illustrates a luminaire with two sources.

### DETAILED DESCRIPTION OF THE INVENTION

Preferred embodiments of the present invention are illustrated in the FIGUREs, like numerals being used to refer to like and corresponding parts of the various drawings.

The present system generally relates to an automated luminaire, specifically to a image projection luminaire. Improvements are disclosed in many areas of image projection luminaire system including but not limited to: picture blending; gamma curve of the blended edge; Kaleidoscopic effect; Control of contrast and brightness of the projected images—RGB Scale; Blending of adjacent mirrored images; Automatic correlation of the colors from LED modules to the colors of the projected images which are described in greater detail below.

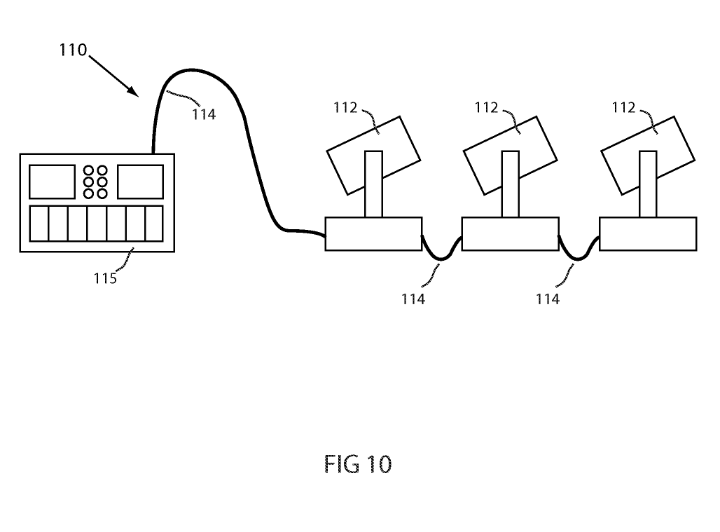

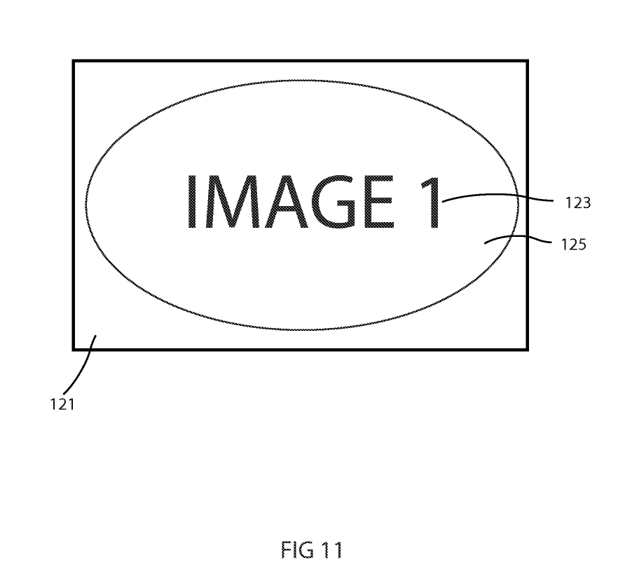

FIG. 10 illustrates an automated image projection luminaire system 110. These systems commonly include a plurality of automated image projection luminaires 112 which typically each contain on-board a light source or light engine (not shown), light modulation devices capable of projecting electronic video or still imagery, electric motors coupled to mechanical drives systems (not shown) and control electronics (not shown). In addition these luminaires 112 may include mechanical drive system and control electronics to control the orientation of the central axis (not shown) of the projected light beam output (not shown). In addition to being connected to mains power either directly or through a power distribution system (not shown), each luminaire is connected is series or in parallel to data link 114 to one or more control desks 115. The luminaire system 110 is typically controlled by an operator through the control desk 115.

Picture Blending

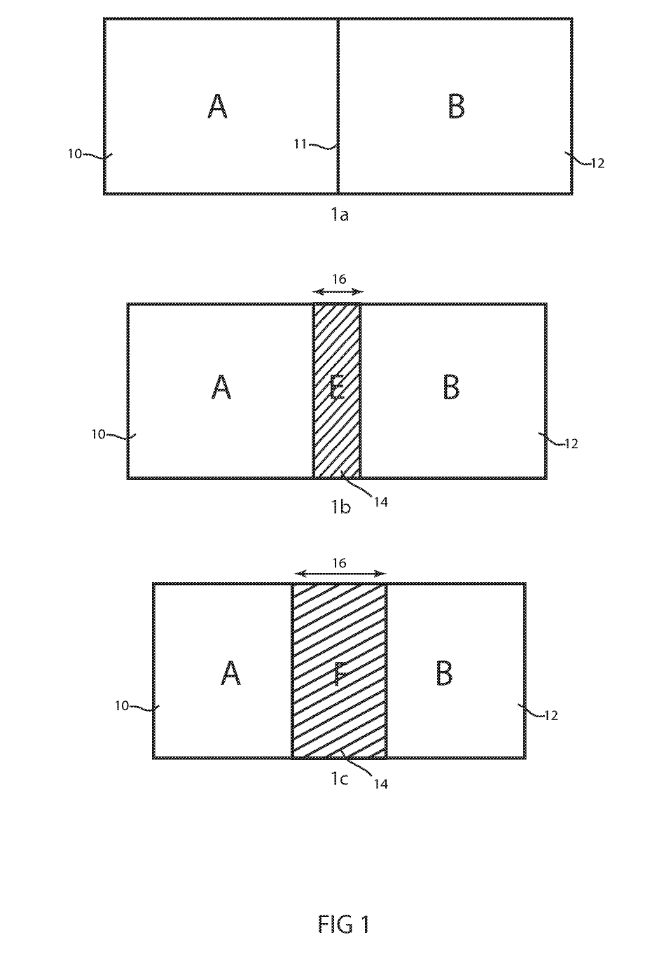

It is known in prior art systems to provide an overlap between adjacent tiled images from two projection luminaires such that the appearance of the join between the two images is minimized and as invisible as possible. One image fades out as the adjacent and overlaid image fades in providing a minimal visible joint between the two images. In the prior art, this overlap or blended edge area is fixed in the luminaire and may typically be approximately 5 percent of the total image size. However it is almost impossible to get an invisible joint using a small blending area like this particularly with large areas of single color such as a blue sky or sea or other generally flat color areas. One aspect of the improved luminaire projection control system is that it provides for complete control by the operator of the size/width of this blending area. In one embodiment the size/width of the blending area may be controlled by the operator through the control communication link (for example DMX512) so as to optimize the blending for the specific imagery being used. FIG. 1 illustrates this feature in an embodiment of the invention. In FIG. 1a two projected images 10 and 12 each with a respective portion A and B of a larger image are projected with no overlap so that their adjacent edges touch. Such a system will produce a visible join line 11 between image portions A and B. In FIG. 1b the two projected images 10 and 12 overlap in a central region 14 with width 16 such that the right section of image portion A overlaps the left section of image portion B to form overlap image section E. This overlap section E represents a demarked boarder edge/boarder area of on the right side of image portion A and a demarked boarder edge area of the left side of image portion B. In this example, both demarked boarder areas contain the same image information. The objective of overlapping eges is to produce a less visible blended join between image portions A and B. In FIG. 1c the two projected images 10 and 12 overlap in a central region 14 where overlap width 16 has been increased from that shown in FIG. 1b. The larger overlap width 16 in overlap image section F will produce an even more gradual blend between image portions A and B and thus may result in a less visible join. The invention allows dynamic adjustment of the width 16 of the overlap region 14 to suit the imagery and application. The operator will pick the blend size/width based on the image being projected so as to minimize the appearance and visibility of the blend or joint between the images. In some cases, it is advantageous to provide a large blend edge width such as 35 percent of the image width. Such a wide blend will cause the join to be minimally visible even across areas of uniform color such as images of the sky, clouds or sea which are very difficult to blend effectively using prior art systems.

In some embodiments, the width will be uniformly adjusted for each joint edge. In other embodiments the blend size/width on each edge/joint of the projected image may be adjusted independently.

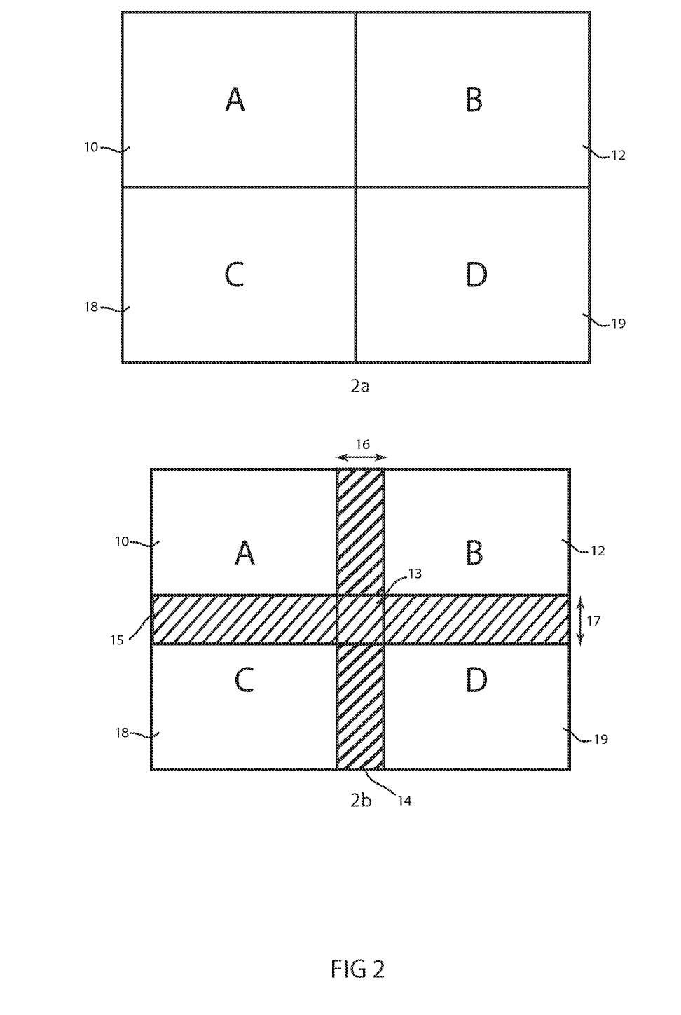

FIG. 2 illustrates a larger system where four projected images 10, 12, 18 and 19 each with a respective portion A, B, C, D of a larger image. FIG. 2a shows the four projected images with no overlap so that the adjacent edges touch and have no blend. In FIG. 2b the four projected images 10, 12, 18 and 19 overlap in region 14 and 15 with horizontal width 16 and vertical width 17. The invention allows dynamic and independent separate adjustment of horizontal width 16 and vertical width 17 so as to optimize the blending between the four images. The central region 13 where there is a double overlap is accounted for by sequential processing of the horizontal 15 and vertical 14 overlaps and no special additional processing is typically required. However, in other embodiments double overlap image sections 13 may be addressed independently of the rest of horizontal 15 and vertical 14 blending image sections for the purposes of blending adjustments/corrections such as those discussed below.

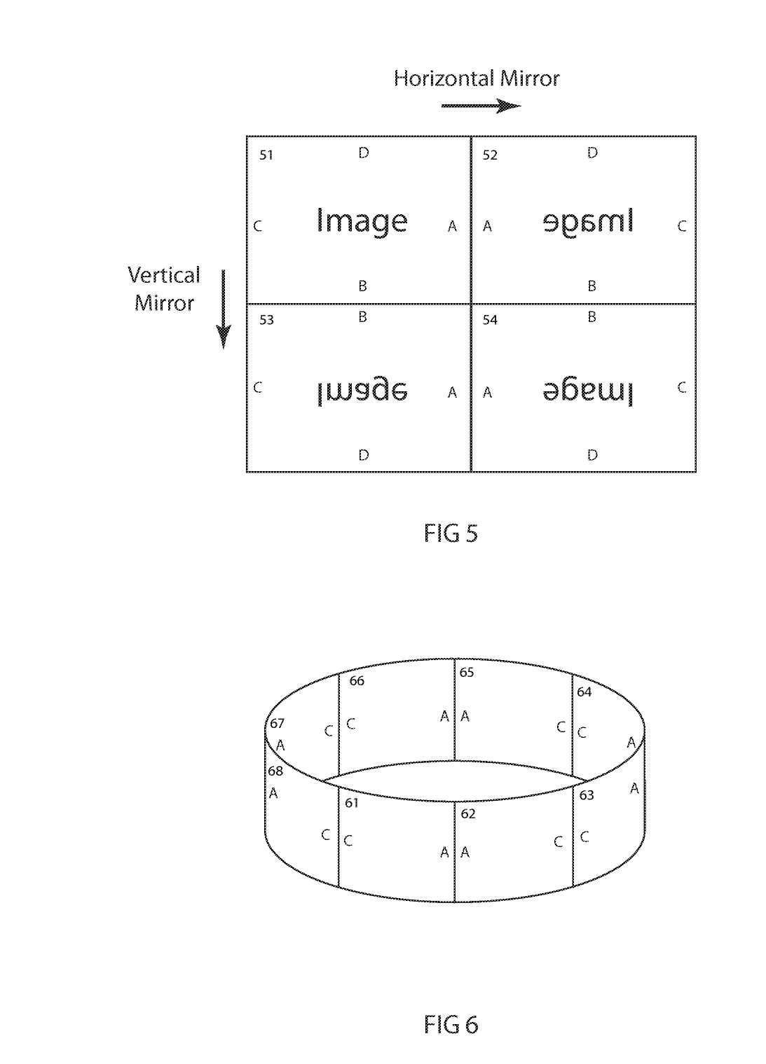

Although four projected images have been herein illustrated the invention is not so limited and any number of images with associated overlapping blend regions may be used and each of those blend regions may be independently and dynamically adjusted for width. Similarly while only four projectors are shown more may be used in other embodiments. Additionally, while in the embodiment shown the projections are against a flat surface, in other embodiments the projections surfaces may have non-flat surfaces such as a projection configuration such as that illustrated in FIG. 6.

Gamma Curve of the Blended Edge

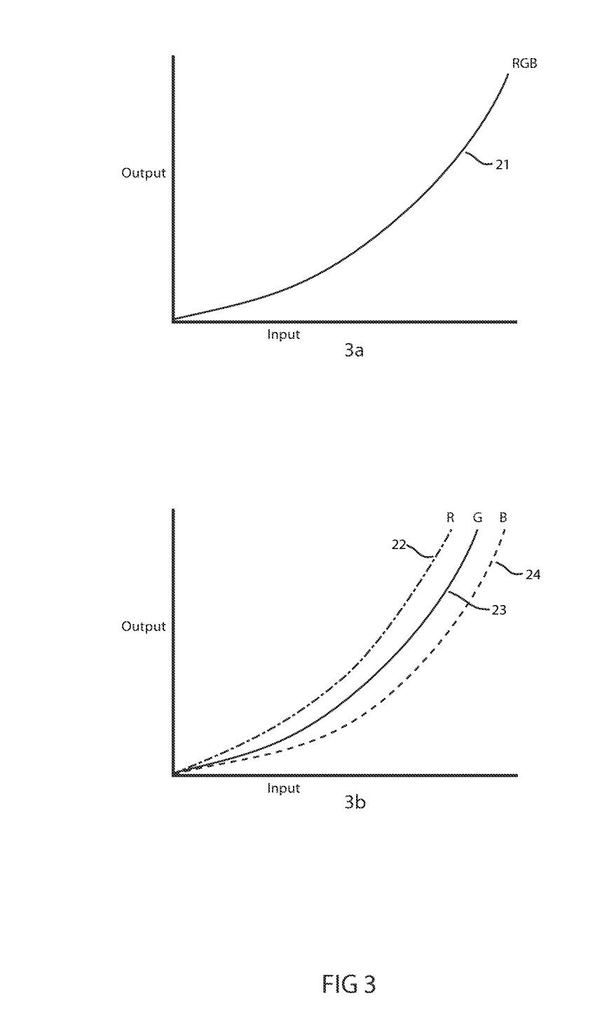

It is known projection art to provide control of the gain curve or gamma curve of the blended area for each luminaire to further assist with the masking of the overlap area such that the blended area appears to be of a consistent brightness. Prior art systems provide for gamma control of the total video signal as a single value. FIG. 3a illustrates a prior art system where a single RGB gamma curve 21 may be adjusted. The improved system provides independent and individual gamma control for the Red, Green and Blue signals separately over the blending area such that any color variations across the blend may be corrected and removed to further remove any visible joint. FIG. 3b illustrates an exemplary embodiment where the gamma curves for Red (R) 22, Green (G) 23, and Blue (B) 24 signals may be individually adjusted across the blend region. This adjustment may be controlled by the operator through the control communication link (typically DMX512) so as to optimize the blending area for the specific imagery being used. Three DMX512 channels may be provided, one each for the Red, Green and Blue gamma adjustment signals.

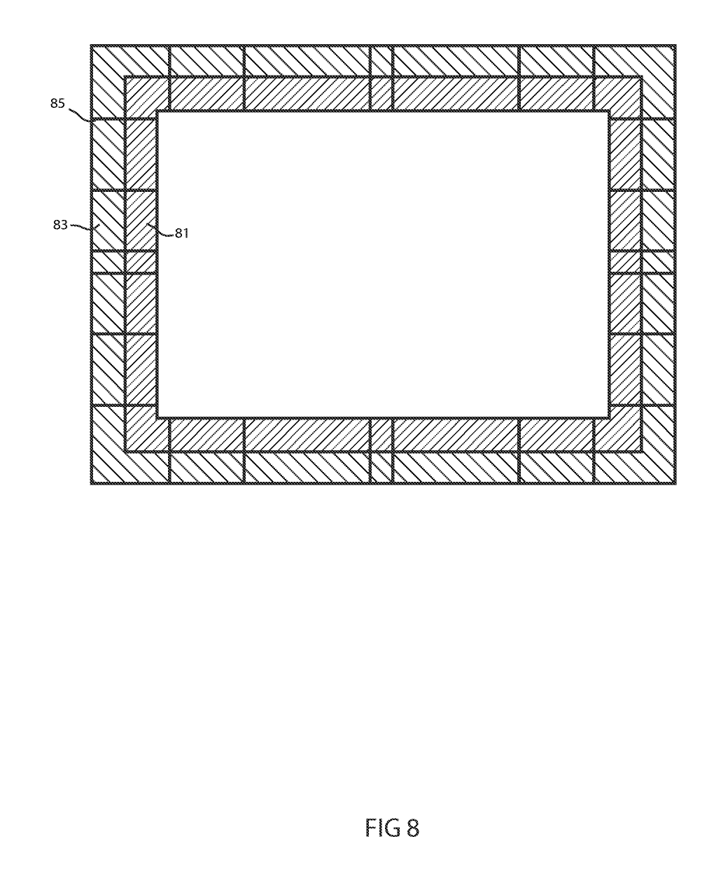

In some embodiments, a test pattern signal as illustrated in FIG. 8 is generated by the system which provides both areas of flat color 81, 83 across the blend and alignment marks 85 so as to facilitate these adjustments. The colors provided typically would include red, green, blue, magenta, cyan and/or yellow but may include others colors as well. The colors provided may be de-saturated colors with a proportion of white so as to allow setting the gamma curve in the center of that curve, or on a location on the curve which allows for adjustment in both directions along the curve. The illustrated test pattern of FIG. 8 is used to make rough adjustments/corrections. More refined adjustments/corrections can be made using representative or actual images to be projected. In other embodiments different or a series of test patterns may be used for example multi color test patterns or a series of single color test patterns.

Each luminaire which contributes output to the total blended image may project these test patterns. Initially the alignment marks 85 may be utilized by the user to light up the test patterns from the various images. This may be done using the mechanical mechanisms (not shown) to direct the orientation of the central axis (not shown projected light beam (not shown) that creates the image. Alignment may also be accomplished by mechanical movement of optical elements (not shown) within the luminaire. Alignment may also be accomplished by digital manipulation of the digital image feed to the light generating engine (not shown) Typically all or a combination of these alignments would be used to align the outputs of the luminaires. An advantage of the present invention is that it allows for control of the size of the blend area not just as part of the alignment process but also after the images have been aligned. This can be reflected in the shape and configuration of the elements of the test pattern which can change in size and shape to reflect the demarked blend areas and non blend areas.

Kaleidoscopic Effect

DMX512 control channels of the luminaire allow the selection of a portion of an image to be extracted and that portion to be rotated and tiled to form a kaleidoscopic effect. This kaleidoscope may be a static image or may be dynamically driven so as to automatically change its parameters at adjustable rates.

Further DMX512 channels may allow selection of:
a) The shape of the mosaic tile chosen from a list comprising but not limited to squares, triangles and rectangles;
b) Mosaic density or size;
c) Selection of the portion of the original image to be tiled;
d) Speed of dynamic change of mosaic;
e) Size range for dynamic change of mosaic;
f) Rotation of mosaic;
g) curve along which the rate adjusts; and
h) parameters of the curve along which the rate adjusts.

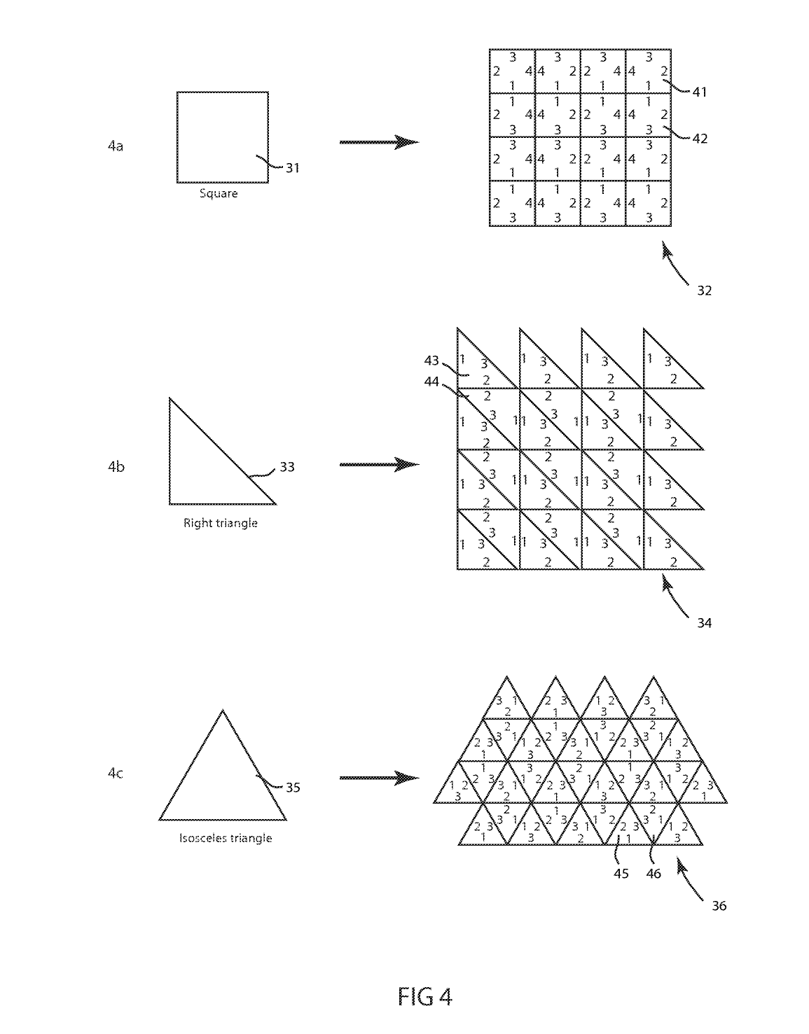

FIG. 4a illustrates an embodiment of the invention utilizing a square mosaic tile, 31. A square portion of the master image is selected as tile 41 which is then mirrored and rotated to tile a plane of images 32. For example Tile 41 and 42 both contain the same image as tile 31, however tile 42 is a mirror image of tile 41 along the edge labeled ‘1’. Similarly every tile is a mirror image of its neighboring tiles. This mirroring ensures that every join between tiles (shown as edges 1, 2, 3 and 4) is a smooth continuous join. The same image is on both side of the join so they must by definition match.

FIG. 4b illustrates another embodiment of the invention utilizing a right triangular shaped tile. As with FIG. 4a the chosen tile 33 is rotated and mirrored in the final tiled plane 34 such that every edge abuts a mirrored version of itself and thus provides a seamless join. For example tile 43 abuts tile 44 along mirrored and rotated edge 2.

FIG. 4c illustrates a further embodiment of the invention utilizing an isosceles triangle tile. As with FIG. 4a the chosen tile 35 is rotated and mirrored in the final tiled plane 36 such that every edge abuts a mirrored version of itself and thus provides a seamless join. For example tile 45 abuts tile 46 along mirrored and rotated edge 3.

### Control of Contrast and Brightness of the Projected Images—RGB Scale

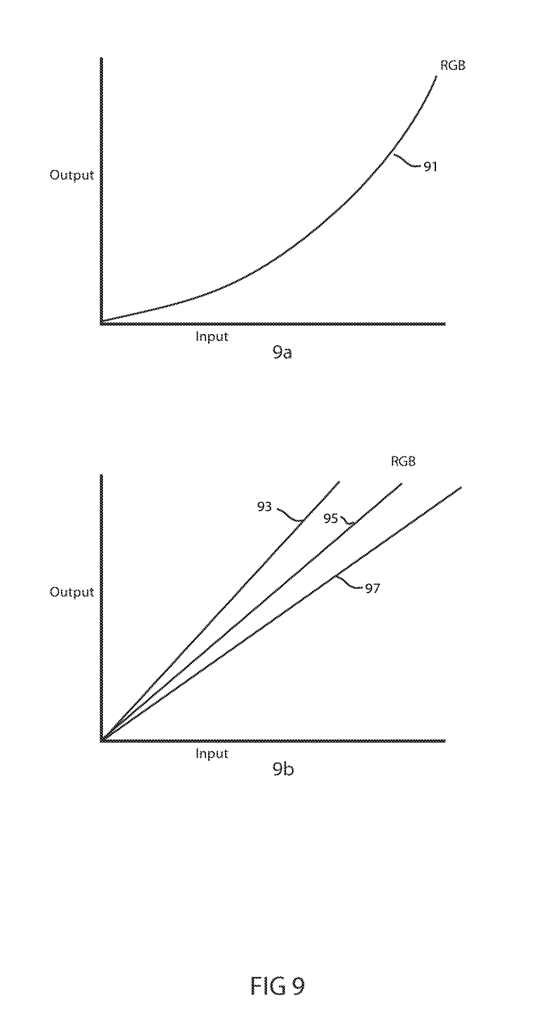

It is well known in the prior art to adjust the lift and gain (brightness and contrast) of projected images. However such manipulations do not allow for non-realistic enhancements of imagery. The improved system provides a novel linear gamma system to digitally enhance or decrease the color range in images. Such a linear gamma with adjustable slope may further be used to improve the apparent brightness and appearance of non-naturalistic images. FIG. 9 illustrates a prior art gamma curve in 9a and an embodiment of a linear gamma system 9b. The slope of the linear gamma may be adjusted to provide a range of linear gammas as shown by lines 93, 95 and 97.

Blending of Adjacent Mirrored Images

It is known to cut a single image into multiple segments that can then each be projected by different adjacent projection luminaires such that a single large version of the original image is created again. For example, an image may be cut into four quarters each of which is output by a different luminaire. The four projected images are then aligned such that a single large image is recreated. The four images may use edge blending to disguise the joins between the portions of the image.

The disadvantage of this technique is that the resolution of the image is reduced in the same ratio as the number of segments used. Described is a method for tiling a single image without cutting it into smaller segments. By mirror imaging the same image into two luminaires the adjacent images are assured of being identical. For example the right edge of the image 51 from the first luminaire will be the same as the left edge of the image 52 from the second luminaire as the images are identical but mirror reversed on the vertical plane. The same technique may also be applied to the top and bottom edges by mirroring on the horizontal plane to generate images 53 and 54.

By continuing the process a large high resolution image of any size comprising any number of duplicates of the original image may be created. Every edge will abut a mirror reversed version of the same image. This feature is particularly suitable for the panoramic projection of simple images such as water, forest, sea, sky, or abstract imagery where the mirroring of adjacent images is not significant.

In a further embodiment mirror reversal and tiling may be combined in any combination. For example a single image may be conventionally split and tiled across two projectors and then that combination mirror reversed to a further two projectors. FIG. 5 illustrates an embodiment of this invention. A single image is projected as four separate images 51, 52, 53 and 54 each from a separate projector. Each image is mirrored along the join line with its neighbors such that the join line abuts two identical, but mirrored, portions of the same image. In FIG. 5 the four edges of the original image are labeled A, B, C and D. Image 51 represents the original unmirrored image. Image 52 is mirrored on the vertical axis such that edge A abuts edge A of image 51. Image 53 is mirrored on the horizontal axis such that edge B abuts edge B of image 51. Finally image 54 is mirrored in both the vertical and horizontal axes such that edge B abuts edge B of image 52 and edge A abuts edge A of image 53. The word ‘Image’ has been accordingly mirrored in FIG. 5 as an illustration of the final composite. (Note that the two mirror transforms applied to produce resultant image 54 are equivalent to a 180 degree rotation to original image 51).

In a yet further embodiment further projectors may be added to form a complete 360 degree ring of images such that the last image will seamlessly blend with the first creating the appearance of a single unbroken and seamless circular image surrounding the viewer. FIG. 6 illustrates this embodiment where a single input image 61 is repeated around a ring of projected images 62, 63, 64, 65, 66, 67 and 68 where each image is a mirror image of the ones on either side.

Automatic Correlation of the Colors from LED Modules to the Colors of the Projected Images.

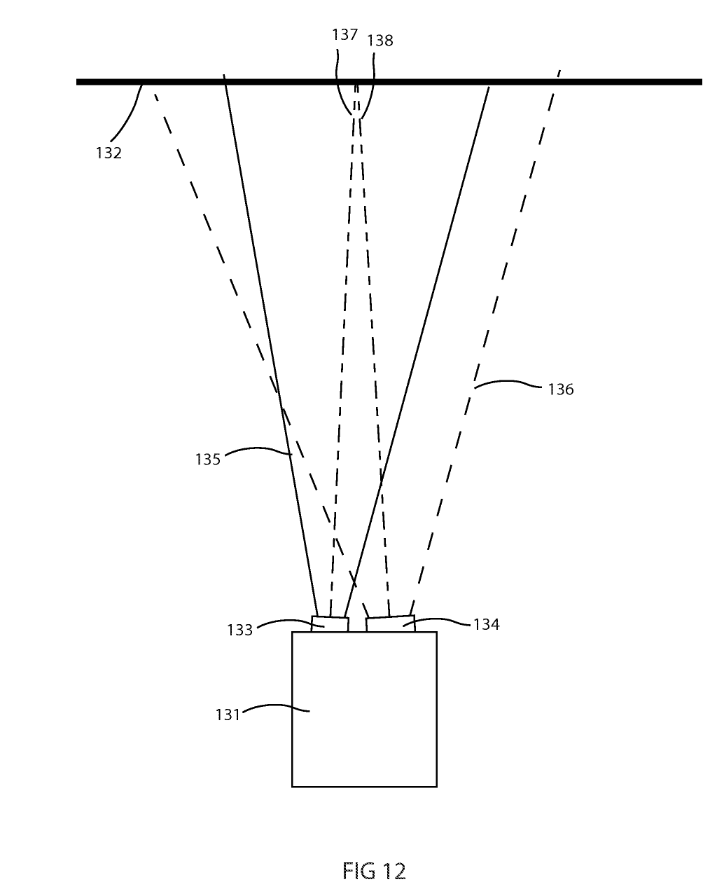

A projection luminaire may have associated with it a color mixing lighting element. This lighting element may incorporate multiple colors of LED emitters allowing the mixing of any color desired by adjusting the percentages of each emitter in the output. For example, it is well known to use LED emitters in Red, Green and Blue that, when combined in the correct proportions, allow the mixing of a desired output color. Such a lighting element may be physically part of the luminaire so as to allow projection of a colored light beam as well as the image. The improved system provides a method for automatically correlating the mixed output color of the light beam from the color mixing lighting element to the output of the luminaire. FIG. 11 illustrates the output produced by an embodiment where the output 123 from a projection luminaire and output 125 from a color mixing lighting element substantially overlap on surface 121 such as that produced by a luminaire 131 illustrated in FIG. 12.

Referring now to both FIG. 11 and FIG. 12, Output 125, 135 is shown in FIG. 11 as an oval for illustrative purposes only to indicate how the two outputs 125, 136, and 123, 135 overlap. In practice the beam 125, 136 from a color mixing lighting element 134 may be soft edged and diffuse providing general illumination on surface 121 132, it may also be round, elliptical or any other shape as known in the art. The shape and character of the color mixing lighting element 134 may be controlled by optical devices in the luminaire not not shown such as beam focus, beam shaping, barn doors and other devices well known in the art.

In one embodiment, the color of the light beam 125 from the lighting element 134 will be automatically adjusted to match the predominant color of the projected image 123 from the luminaire. In a further embodiment the color of the light beam 136 from the lighting element 134 will be automatically adjusted to be complementary to the predominant color of the projected image 123 from the luminaire 131. Many other arrangements are possible such as those using Newton's color wheel to select attractive color combinations. The particular arrangement to be utilized may be selected by the user using DMX512 control channels of the luminaire.

In yet further embodiments the luminaire may be fitted with a plurality of color mixing lighting elements such that each color mixing lighting element may be controlled independently and produce different colors. Each color mixing lighting element may be automatically controlled to produce any of the color arrangements discussed above. The color of each color mixing lighting element may further be affected by its position relative to the luminaire, projected image. For example a color mixing lighting element producing light on the left side of the luminaire projected image may be controlled by the predominant color on the left side of the image and a color mixing lighting element producing light on the right side of the luminaire projected image may be controlled by the predominant color on the right side of the image.

Precut Images

A disadvantage of splitting a single image across multiple projection luminaires using the tiling and blending technique described above is that the resolution of the original image is divided across all the projection luminaires. For example if the original image has a 1024×768 pixel resolution and is merged across two luminaires then the 1024 horizontal is divided between those two luminaires such that each projection luminaire only provided 512 horizontal pixels.

In many cases however the source image is of a much higher resolution and it would be advantageous to be able to utilize the full resolution of each projection luminaire to provide a 2×1024=2048 horizontal pixels of resolution (approximately as some pixels will be lost in the blended region between the two units). To achieve this an original image of 2048 horizontal pixels may be pre-cut by the user in external software so as to generate two images, each of 1024 horizontal pixels, that each represent slightly more than half of the final image. (The image cuts of more than half or 50% allows a blending or overlapped area between the two portions of the image).

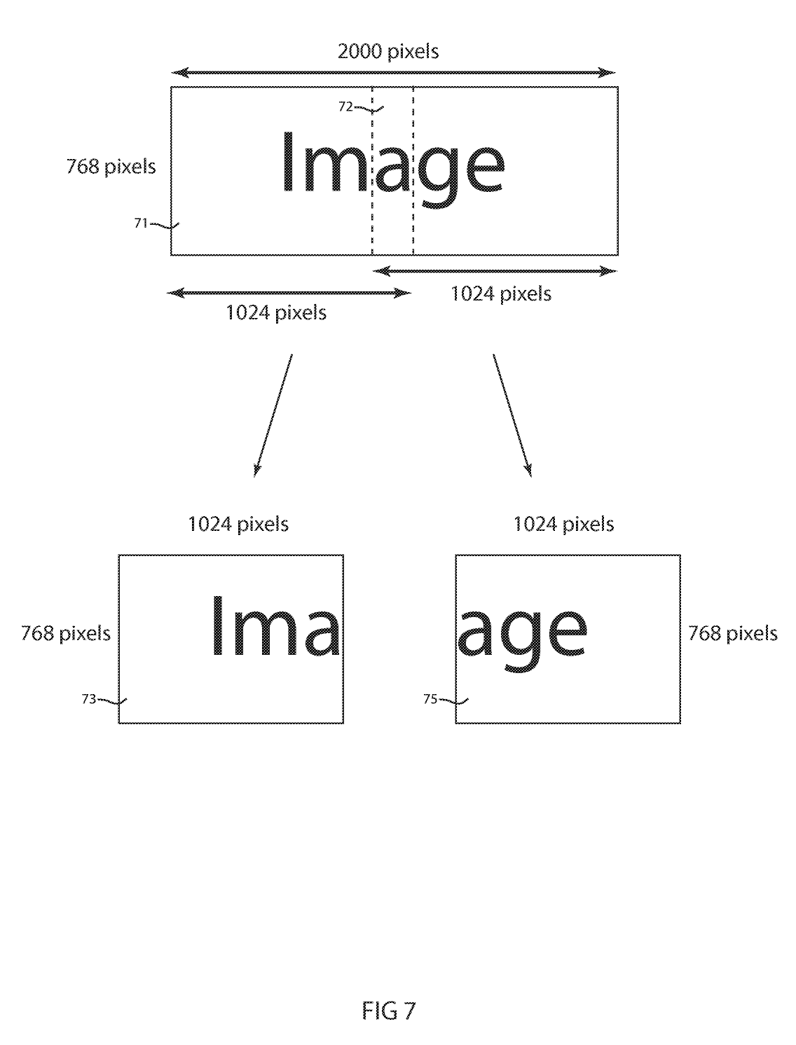

FIG. 7 illustrates this embodiment. Original source image 71 has a resolution of 2000 pixels wide by 768 pixels high. It is cut into two images, each 1024 pixels wide by 768 pixels high such that the two images have an area in common or overlap 72. The two resultant images 73 and 74 may then be projected by two projectors where a blended join is formed between the two images 74 and 75 with an overlap of region 72.

The improved system then blends together the pre-cut images of the original image being projected by projection luminaires so as to re-create the original image at each luminaire's full resolution. The original image may be pre-cut into any number or arrangement of portions so as to match the number and arrangement of projection luminaires. The original image to be pre-cut may be a still image or a moving video image.

### Refresh Rate of Output

It is common for generated and projected imagery to be produced at a 60 Hz refresh rate. This frequency is standard for computer-generated images. However, there are times when material is provided at a 50 Hz or other refresh rate. For example images from European video cameras will be generated at 50 Hz refresh rates and images scanned from a film may be designed to be projected at 50 Hz, 49.998 Hz or 48 Hz. If no action were taken to correct the situation, then the projection luminaire would project such imagery with a noticeable flicker caused by aliasing between the different 50 Hz and 60 Hz refresh rates of the source image and output of the luminaire. The improved system provide a method for recognizing such images with differing refresh rate requirements and changing the various timing, blanking, and refresh timing signals of the generated video output such that the projection device will correctly switch its output to a matching refresh rate. In one embodiment this change is effected by altering parameters and control channels on a computer video output card.

### Provide Feed of Final Output

It is well known in such image systems to provide many image manipulations including those described herein. These manipulations may provide for the combination of multiple image sources each of which has also been manipulated. Such manipulations may include image scaling, rotation, distortion, color editing, alpha channel blending, matting and many other effects well known in the art. It would be useful to be able to take the final manipulated image and capture it into the storage system so that it may be used as a single source in a future image manipulation process. For example a system may allow the superimposition of two images, if we then capture the resultant output and provide it as a single source then a further 3^{rd} image may be superimposed. By repeating this process an unlimited number of image layers may be manipulated and utilized. The prior art offers such capture systems but they are slow and cannot capture imagery in real time or slow down the image processing. The improved system provides means for capturing and storing the final output from the image manipulations in real time without affecting the output. In a further embodiment the manipulated image may also be captured at intermediate points in the manipulation chain. Such captured output may be used immediately, stored for future use as a source, sent to other units or broadcast.

Attach as Attachment A the contents of which are incorporated herein by reference is a copy of a User Manual for Robe Lighting SRO's Digital Spot 7000 DT series luminaire.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. A projection luminaire comprising:
a light engine for generating a geometrically regular shaped beam of light with demarkable boarder areas;
image processor proving user control of the size of the demarkable boarder areas;
image processor providing user to control parameters of the demarked boarder areas independently of control of such parameters of the image not part of the demarked boarder areas.

2. A projection luminaire of claim 1 where the controlled image parameter is the independent control of brightness and/or contrast.

3. A projection luminaire of claim 1 where the controlled image parameter is the independent control of intensity of color components of the image such as red, and/or green, and/or blue.

4. A projection luminaire of claim 1 where the controlled image parameter is the independent control of gamma correction.

5. A projection luminaire of claim 4 where the control curve of the gamma correction is controllable by the user.

6. A projection luminaire of claim 5 where the control curve of the gamma correction is linear.
